(19) United States
(12) Patent Application Publication
(10) Pub. No.: US 2012/0019204 A1
(43) Pub. Date: Jan. 26, 2012

(54) Car Navigation System

(75) Inventors: Shigeru MATSUO, Hitachinaka (JP); Hiroki Uchiyama, Hitachinaka (JP)

(73) Assignee: Hitachi, Ltd., Tokyo (JP)

(21) Appl. No.: 13/186,558

(22) Filed: Jul. 20, 2011

(30) Foreign Application Priority Data
Jul. 22, 2010 (JP) 2010-164437

(51) Int. Cl. H02J 7/00

(52) U.S. Cl. 320/109

(57) ABSTRACT

If a route has not yet been set in a car navigation apparatus, and when a vehicle approaches a specific crossing or a charging station located ahead of a current-driving road, or when remaining charge of a battery becomes less, the navigation apparatus retrieves and displays information about charging stations of the respective branching directions. When the vehicle approaches a specific crossing, the navigation apparatus guides information for indicating whether or not a charging station is present, a distance, and whether or not the vehicle can reach the charging station with respect to each of directions branched from the specific crossing. Also, when a charging station is located ahead of the road, the navigation apparatus retrieves charging stations of the respective branching destinations at a specific crossing located in front of the road, and judges whether or not the vehicle can be driven up to the respective retrieved charging stations.

### BACKGROUND OF THE INVENTION

1. Field of the Invention

The present invention generally relates to a car navigation apparatus which is mounted on an electric vehicle. More specifically, the present invention is directed to the car navigation apparatus capable of automatically displaying information about charging stations.

2. Description of the Related Art

JP-A-2003-262525 describes a method for seeking a route as a car navigation for guiding charging stations used for electric vehicles and for guiding a charging station located along the route while this vehicle is conducted, a method for displaying locations of charging stations on a map by marks, and an inventive idea for retrieving charging stations located around the present place so as to list up the retrieved charging stations.

Also, JP-A-2007-148590 discloses a method for calculating a vehicle-drivable distance based upon a remaining charged amount of a battery mounted on a vehicle, and for guiding charging stations located within this vehicle-drivable distance.

### SUMMARY OF THE INVENTION

Moreover, in these methods, in order to display information about charging stations, vehicle drivers are required to operate the car navigation apparatus. In other words, in order to guide the charging stations located along the route through which the electric vehicles are traveled, as explained in JP-A-2003-262525, the vehicle drivers must retrieve a target place in advance so as to seek the route. When an electric vehicle is driven without seeking a route, as explained in JP-A-2007-148590, charging stations must be retrieved within a vehicle-drivable range based upon a present position. Also, in the case that charging stations are displayed on a map, in order to view information about charging stations positioned outside a range of a screen under display, the map is required to be scrolled, and a scale of this map is required to be changed.

However, since complex car navigation operation cannot be performed while driving electric vehicles, vehicle drivers are required to stop the electric vehicles in order to acquire information and to perform route seeking operation and map displaying operation, so that the vehicle drivers may have cumbersome feelings. Further, if guidance of charging stations are continuously displayed, then there are some possibilities that the vehicle drivers may adapt themselves to the guidance continuous display situations, and therefore, may overlook an actually necessary display. As a result, the vehicle drivers are required to pay their attentions to timing and contents, at which the guidance of the charging stations is displayed. As a consequence, the below-mentioned techniques are required: That is, even in such a case that manipulations are not made by vehicle drivers while driving electric vehicles, information related to charging stations is provided at proper timing.

In order to solve the above-described problems, when an electric vehicle approaches a specific crossing which corresponds to a crossing where major roads of either a prefectural road level or a national road level cross with each other, or another crossing where roads of either the prefectural road level or the national road level cross with each other and the vehicle turned its direction, which has been recorded in a drive history; or when a charging station is detected along a forward road where the vehicle is being driven; otherwise when a battery remaining charged amount of the own vehicle becomes smaller than, or equal to a predetermined value, information about charging stations present in the respective branching directions is retrieved to be displayed.

When the vehicle approaches a specific crossing, the below-mentioned information is guided for each of directions branched from this specific crossing, namely, whether or not a charging station is present, a distance, and whether or not the vehicle can reach the charging station. As a result of retrieving the charging stations located along the roads branched from the specific crossing in the respective directions, in the case that there is such a direction that the vehicle cannot reach the charging station based upon a battery remaining charged amount of the vehicle, a charging station is again retrieved in an area around the road of this direction, and such a charging station is retrieved at which the battery can be charged if the vehicle more or less makes a detour. As a result of this retrieved, if the charging station is not present in the area around the road, then such a display is made that the vehicle cannot reach the charging station in this branching direction; a charging station located around the position of the own vehicle is retrieved; and a position, a name, and a distance of the retrieved charging station are displayed.

When a charging station is detected in front of a road where the vehicle is presently being driven, a specific crossing is retrieved which is located furthermore ahead of the road where the vehicle is presently driven; a charging station is retrieved in each of branching directions of this specific crossing; a judgement is made whether or not the vehicle can be driven to the charging stations in the respective branching directions; and a judgement is made where or not the vehicle is required to be charged at the detected charging station located ahead of the road.

When a remaining charged amount of the battery of the own vehicle becomes smaller than, or equal to a predetermined value, it is retrieved whether or not a charging station is present up to a specific crossing in a vehicle-drivable range located ahead of the road where the vehicle is presently being driven; and a judgement is made whether or not the vehicle can be driven to the retrieved charging station. Also, if the charging station is not present up to this specific crossing, then charging stations of the respective directions branched from the above-described specific crossing are retrieved, and a judgement is made whether or not the vehicle can be driven to the retrieved charging stations. If the vehicle cannot reach the retrieved charging stations, then a charging station located around the present vehicle position is retrieved to be guided.

In accordance with the present invention, when the vehicle approaches the specific crossing having large possibilities where the own vehicle is branched, it is represented whether or not the charging stations are present in each of the branching directions. As a result, the vehicle driver can acquire the information about the charging stations along a roughly scheduled driving direction at proper timing without her operation.

Also, since the vehicle driver can further acquire the information for indicating whether or not the vehicle can reach the represented charging stations, the vehicle can be charged before the vehicle cannot be driven.

Also, when a charging station is found out while the vehicle is driven, the vehicle driver can acquire information required for judging whether the vehicle can reach a target place even if this vehicle is not charged at the found charging station, or the vehicle is required to be charged here.

Moreover, even in such a case that a remaining charged amount of the battery becomes smaller than, or equal to a predetermined value, since the information as to the charging stations for each of the branching directions along the driving directions is displayed, the vehicle can be charged before the vehicle cannot be driven.

### BRIEF DESCRIPTION OF THE DRAWINGS

FIG. 1 shows a diagram for showing a functional configuration of a car navigation apparatus according to the present invention.

FIG. 2 shows a diagram for indicating a display example for guiding charging stations when an electric vehicle approaches a specific crossing while route guidance is not carried out.

FIG. 3 is a flow chart of a process for guiding a charging station at the specific crossing.

FIG. 4 is a flow chart of a process for detecting a specific crossing.

FIG. 5 is a flow chart of a process for performing a guidance display of a charging station.

FIG. 6 is a diagram for representing another example of a guidance display.

FIG. 7 is a diagram for showing an example of a display for guiding charging stations when the electric vehicle approaches a charging station of a route.

FIG. 8 is a flow chart of a process for guiding the charging stations when the electric vehicle approaches the charging station of the route.

FIG. 9 is a diagram for indicating an example of a guidance display when a remaining charged amount of a battery becomes smaller than, or equal to a predetermined value.

FIG. 10 is a flow chart of a process for performing guidance of charging stations when the remaining charged amount of the battery becomes smaller than, or equal to the predetermined value.

FIG. 11 is a flow chart of a process for performing a guidance display of charging stations in response to density of charging stations located around the position of the own electric vehicle.

FIG. 12 is a diagram for representing a data format of a charging station DB.

FIG. 13 is a diagram for explaining a data format of a drive history DB.

FIG. 14 is a flow chart of a process for displaying a branching direction drawing on a guidance screen.

### DETAILED DESCRIPTION OF THE INVENTION

Referring now to drawings, a description is made of a car navigation apparatus according to an embodiment of the present invention.

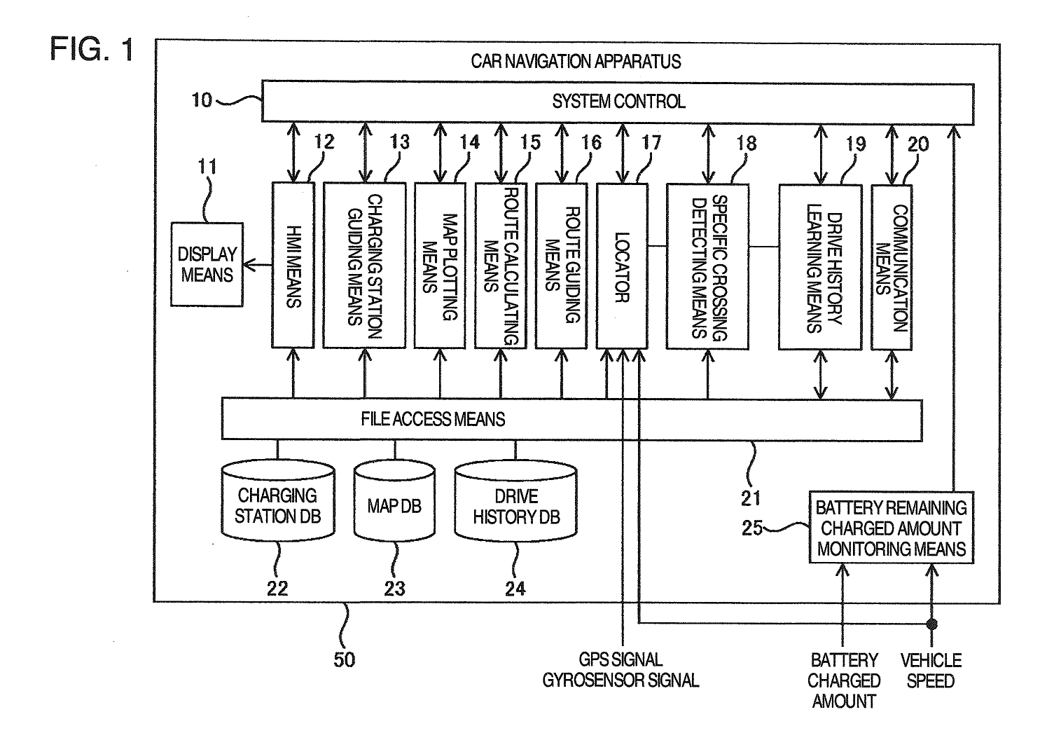

FIG. 1 indicates a functional configuration of a car navigation apparatus 50 according to the present invention. The car navigation apparatus 50 is configured by the below-mentioned respective means. A display means 11 displays information such as a map, a menu, and the like, and employs a liquid crystal display device. An HMI (Human Machine Interface) means 12 determines a content to be displayed on the display means 11, and controls displays of a menu, a map, a guidance screen, and the like. A charging station guiding means 13 accesses a charging station DB (Data Base) 220 so as to display a direction, a distance, and the like of a charging station on the display means 11.

A map plotting means 14 accesses a map DB 23 so as to plot a map which is displayed on the display means 11. A route calculating means 15 accesses the map DB 23 so as to calculate a route from a present place to a target place. A route guiding means 16 guides an electric vehicle in accordance with the route calculated by the route calculating means 15. A locator 17 positions a present position of the vehicle. The locator 17 calculates positions of latitude/longitude by employing a GPS (Global Positioning System), a gyrosensor, and a vehicle speed signal, and compares the calculated positions of the latitude/longitude with positional information of a road stored in the map DB 23 to judge that the vehicle is being driven on which road. Road data of the map DB 23 are managed based upon numbers called as link numbers which are given to roads in the unit of a single road, have attribute information such as superhighways, national roads, prefectural roads, and city roads, and also have positional coordinates which approximate road shapes by polygonal lines. Further, the map DB 23 has coordinates which approximate boundaries of cities, towns, and villages by polygons in order to display present places and a place name of a specific place.

A specific crossing detecting means 18 detects existence of a crossing where major roads in a level of either national roads or prefectural roads cross with each other in front of a road where a vehicle is being driven, or existence of a crossing between the last-mentioned road and a road whose level is lower than, or equal to a level of a city road at which the vehicle turned from a major road in the past. As a result, a crossing where a vehicle driver branched in the past from a major road to a not-major road, which are extracted from historical information, is further contained in specific crossings in addition to crossings having such a possibility that a large number of vehicles branch, namely so-called “major crossings” where major roads cross with each other, so that such a crossing which is judged as an important crossing to the vehicle driver herself can also be contained in subjects for guidance in order to guide charging stations. A drive history learning means 19 records roads where the vehicle is being driven in a drive history DB 24 in the unit of the road link in the drive order.

A communication means 20 is used when information is downloaded from a server (not shown) on the Internet, and can acquire, for example, latest positional information about charging stations, and the like. A file access means 21 arbitrates and controls accesses to the respective databases as to the charging station DB 22, the map DB 23, and the drive history DB 24.

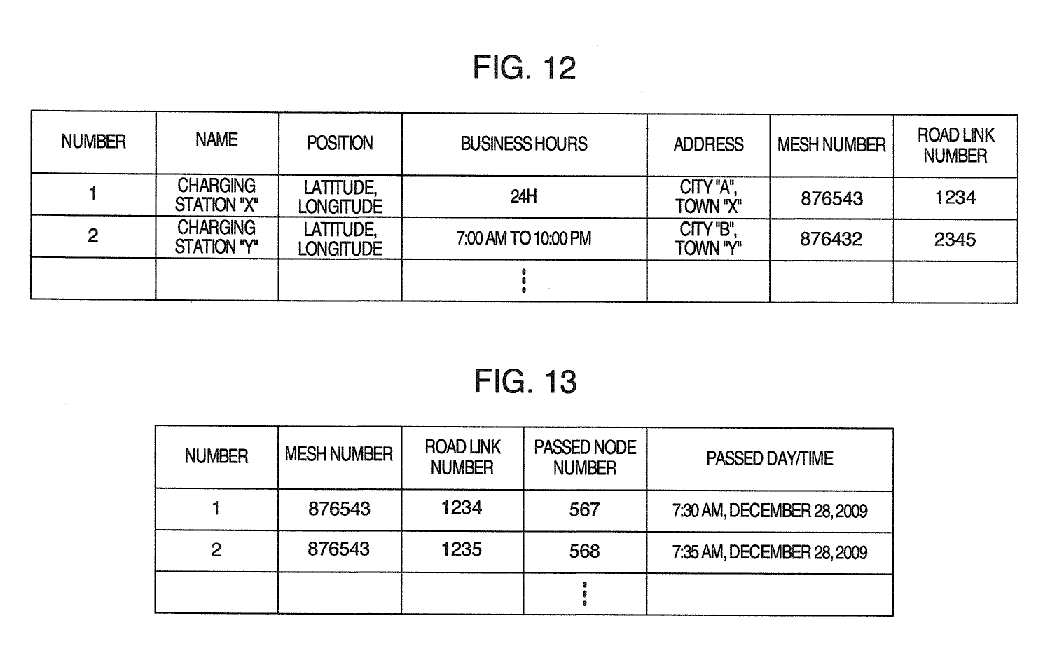

A battery remaining charged amount monitoring means 25 calculates how long a vehicle can be driven based upon a remaining charged amount by employing a charged amount of a battery and information about a speed of the vehicle. Since a drive distance is calculated by integrating the vehicle speeds for a predetermined time, and a change amount of the remaining charged amounts of the battery is investigated as to the time period, so that a consumed electric power amount of the battery when the vehicle is driven over a predetermined distance can be grasped. Since the remaining charged amount of the battery is divided by this consumed electric power amount, a vehicle-drivable distance can be calculated. For instance, it is possible to sense a change in vehicle-drivable distances by checking whether or not, for instance, an air conditioner and a light are turned ON. A charging station DB 22 is a database for storing information of charging stations, and has a data format shown in FIG. 12. The charging station DB 22 has information with respect to each of charging stations as to a name, a location, business hours, an address, a mesh number of a map, and a road link to which the charging station faces in order to grasp that the relevant charging station is present along which road. While mesh numbers and road links correspond to information utilized to easily retrieve charging stations located along roads, the mesh numbers are such numbers which divide maps of all over the country into predetermined rectangular areas, and road link numbers are such numbers which are applied to respective roads within this mesh. The business hours are employed in order that time for performing guidance is compared with the business hours so as to guide only charging stations which are open at this time.

The drive history DB 24 is a database for storing roads on which a vehicle drove as road links, and has a data format indicated in FIG. 13. The roads on which the vehicle drove are recorded in the drive history DB 24 in the drive order. Also, since node numbers through which the vehicle passed are recorded, crossing information is recorded in the drive history DB 24. For instance, such a history that a “number” is “1” implies a record in that the vehicle passed “at 7:30 AM on Dec. 28, 2009,” a road link having a number of “1234” of a map of such a section that a “mesh number” is “876543”, and a node (crossing) having a number of “567.”

Next, with respect to operations in which the car navigation apparatus 50 performs guidance displays of charging stations under such a condition that the car navigation apparatus 50 does not guide routes, in the case that proper charging stations are guided, it is important to make guidance capable of assisting judgements of vehicle drivers based upon the below-mentioned three guidance situations: These guidance situations are 1) whether or not a charging station is located along a driving destination within a vehicle-reachable range; 2) when a vehicle approaches a charging station, a battery of the vehicle must be charged here, or the battery of the vehicle is not yet charged here; and 3) when a remaining charged amount thereof becomes low, even if the vehicle is continuously driven, then the vehicle can reach the charging station, or the vehicle must be quickly driven to the near charging station. However, in such a case that the route guidance is not performed, since the car navigation apparatus 50 cannot previously grasp roads on which the vehicle will be driven from now, the above-explained guiding operations can be hardly carried out.

As a consequence, in accordance with the present invention, instead of making guidance with employment of a drive route of a vehicle, in addition to a crossing having such possibilities that a large number of vehicles are branched thereon, which is known as a so-called “major crossing” where major roads of either a national road level or a prefectural road level cross with each other, another crossing extracted from historical information of the own vehicle, at which a driver of this vehicle turned in the past from the major road to a road having a level lower than, or equal to a city road level is also contained in such crossings which are judged to be important for the vehicle driver herself in order to guide charging stations. These crossings are defined as specific crossings which constitute subjects for guiding the charging stations.

Then, when at least any one of the below-mentioned situations is established, the car navigation apparatus 50 judges possibilities at which a vehicle can reach charging stations located in respective branching directions from a forward specific crossing, indicates a driving direction along which the vehicle cannot reach a charging station, and represents a charging station which should be used in charging operation: These situations are 1) whether or not the vehicle nears the specific crossing; 2) whether or not a chance for charging operation comes; and 3) whether or not the vehicle is brought into such a condition that charging operation is required.

In correspondence with these respective situations, a description is successively made of such a case that a guidance display is carried out at each of the below-mentioned timing, namely, 1) when the vehicle approaches the specific crossing; 2) when a charging station is detected which is located ahead of an area along a road where the vehicle is being driven; and 3) when a battery remaining charged amount of the own vehicle becomes lower than, or equal to a predetermined value.

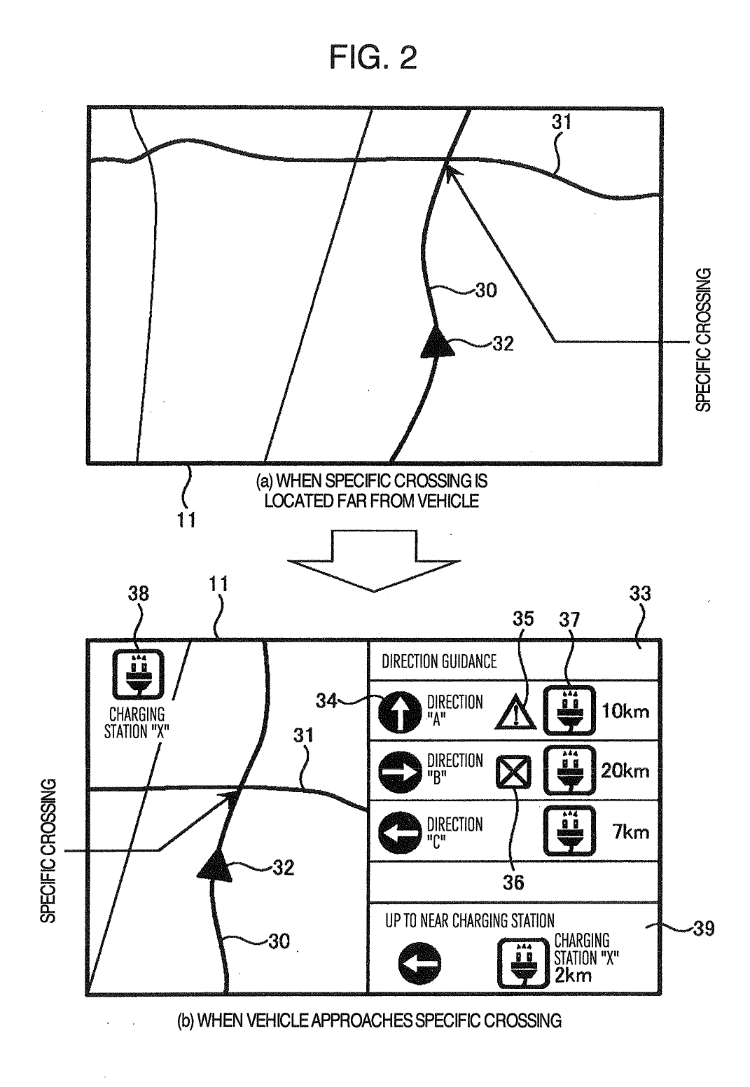

FIG. 2 shows a guidance example of the above-described situation: (1) when the vehicle approaches the specific crossing. As previously described, the specific crossing implies the major crossing where the major roads cross with each other, for instance, a national road crosses another national road, a national road crosses a prefectural road, and a prefectural road crosses another prefectural road; or implies such a crossing that while the road where the vehicle is presently being driven is a major road such as a national road, or a prefectural road and has been recorded in the drive history DB 24 as a history that the vehicle drove this crossing in the past, furthermore, at which the driving direction of the vehicle was changed to a road other than the major road such as the national road or the prefectural road. While a national road and a prefectural road are trunk roads, since there are large possibilities that a branching point of these roads constitutes an important starting point when a vehicle is driven over a long distance, this branching point is suitably employed as a location point by which a destination is predicted under such a condition that a route is not indicated.

Also, as to a road on which a vehicle was driven many times in the past, even when a crossing of this road is not a crossing of a trunk road, since there are some possibilities that the vehicle is again branched on this crossing at this time, this crossing is also defined as the specific crossing. In these specific crossings, such a display is made that whether or not a charging station is present along each of driving directions. Further, a seeking result of a charging station for each of branching roads at a specific crossing, and judging results of vehicle-reachable possibilities with respect to the respective charging stations are represented, and as to such a charging station predicted as a vehicle-not-reachable charging station, the nearest charging station is represented as a substitutable charging station.

Firstly, under such a condition that a distance between a position 32 of a vehicle which is being driven on a national road 30 and a specific crossing where the national road 30 crosses another national road 31 is a long distance, as indicated in FIG. 2(a), this is a general map display screen condition. Thereafter, when the vehicle approaches the specific crossing, as represented in FIG. 2(b), direction guidance 33 is displayed on the right side of the screen. In the direction guidance 33, the below-mentioned items are displayed: namely, an arrow mark 34 which indicates a branching direction at the specific crossing; a direction name of each of the branching directions; an attention mark 35, or a warning mark 36, which indicates whether or not the vehicle can be driven up to a next charging station; a charging station mark 37 which represents that a charging station is located along a road of each of the branching directions; and a distance up to the relevant charging station.

The attention mark 35 indicates that although the charging station is not located along a branched road, this charging station is located within a range defined from this branched road by a specific distance. The warning mark 36 is displayed in such a predicted case that under the presently remaining charged amount, the vehicle cannot be driven up to a charging station located on the branched road, or within the range defined from this branched road by the specific distance. Then, if the warning mark 36 is displayed, then such a display 39 for guiding the nearest charging station (charging station “X”) is made on a lower right portion of the screen. The nearest charging station indicates such a possibility that the vehicle cannot be driven if the vehicle is not charged at this charging station, since there is no charging station around the branched road if the vehicle is directly branched to a direction “B.” When an indication portion 38 of this nearest charging station (charging station “X”) on the map is touched, route guidance up to the nearest charging station (charging station “X”) is performed.

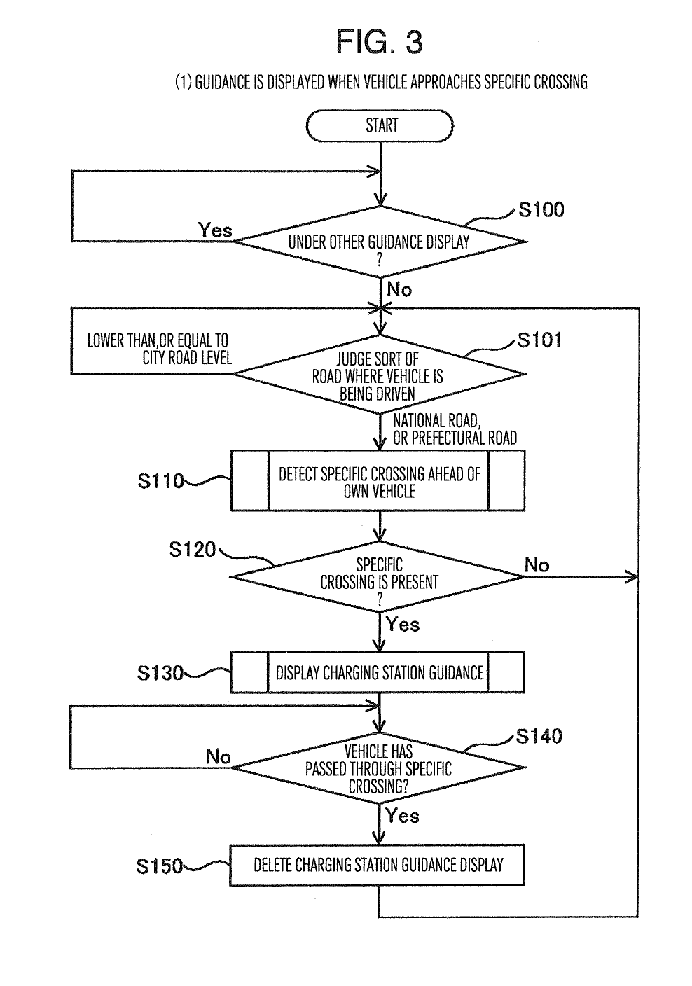

FIG. 3 indicates a process flow for guiding charging stations at this specific crossing. The charging station guiding means 13 judges whether or not another guidance is performed in order to prevent multiple operations (S100). When a decision is made that which guidance display is performed with a first priority, the process previously started to perform the guide display is carried out with the first priority. Next, the charging station guiding means 13 reads information of a road link corresponding to the present position acquired by the locator 17, and judges whether or not the road on which the vehicle is presently being driven is such a major road having either the prefectural road level or the national road level by referring to a road sort to which this road link belongs (S101). If the above-described road is the road having either the prefectural road level or the national road level, then a specific crossing located ahead of a preset distance (for example, 300 m) is detected by the specific crossing detecting means 18 (S110). As a result, if the specific crossing is present on the road where the vehicle is presently being driven up to the preset distance (S120: Yes), then the charging station guiding means 13 performs displays for guiding charging stations depending upon destination directions at this specific crossing (S130). The processes defined from the step S100 to the step S120 are processes which are periodically performed while the car navigation apparatus 50 is initiated. After the charging station guidance displays, depending upon the destination directions, at the specific crossing in the step S130 have been made, the charging station guiding means 13 confirms that the vehicle passed through this specific crossing (S140), and deletes the guidance displays of the charging stations (S150).

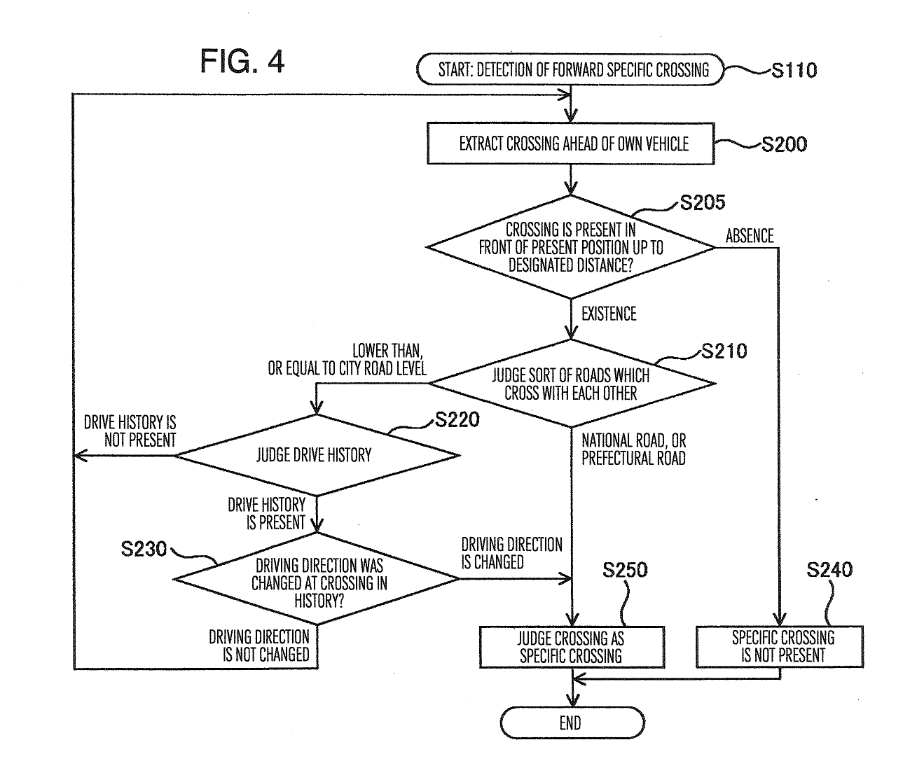

FIG. 4 is a flow chart for showing, in detail, the detecting process of the specific crossing by the specific crossing detecting means 18 in the step S110 of FIG. 3. Firstly, the specific crossing detecting means 18 acquires a forward crossing which subsequently appears as to the road on which the vehicle is presently being driven based upon road information read from the map DB 23 via the file accessing means 21 (S200). As to existence/absence of a crossing, since a road link for configuring the crossing has been connected to a node indicative of the crossing, when the road link is traced along a driving direction, if the node information thereof is viewed, then it is possible to grasp whether or not the road link has been connected to the crossing. Also, it is possible to grasp another road which crosses at the same crossing based upon another road link information which is connected to the node of the same crossing. Then, the specific crossing detecting means 18 checks whether or not a crossing is present between the present position and a forward position from the present position by a designated distance (S205). Next, the specific crossing detecting means 18 judges whether or not a road sort of another road connected to the crossing (namely, node) extracted in the step S200 is the prefectural road level, or the national road level (S210). If the sort of another road connected to the road on which the vehicle is presently being driven at this crossing is either the prefectural road level or the national road level, then the specific crossing detecting means 18 judges that this crossing is the specific crossing (S250).

In the case that the specific crossing detecting means 18 judges in the judgment of the step S210 that a sort of a road which crosses the road where the vehicle is presently being driven at the crossing found within the specific distance is lower than, or equal to the city road level, the specific crossing detecting means 18 judges whether or not the vehicle passed through this crossing in the past (S220). This is such a case that while the road link where the vehicle is presently being driven has been recorded in the drive history DB 240, driving of the vehicle is continuously performed ahead of this road link, and driving of the vehicle up to a road link where the vehicle curves at a crossing which should be judged have been recorded. Then, in the case that there is such a history that the vehicle passed through this crossing, the specific crossing detecting means 18 investigates whether or not data for indicating that the vehicle was branched at this crossing and changed the driving course has been recorded in the drive history DB 240 so as to judge whether or not the vehicle changed the driving course at this crossing (S230). If the vehicle was turned to change the driving coarse at this crossing, then the specific crossing detecting means 18 judges that this crossing is the specific crossing (S250). If there is no such a drive history that the vehicle passed through this crossing, or the vehicle did not change the driving course at this crossing, then the specific crossing judging means 18 judges that this crossing is not the specific crossing, and the process is returned to the step S200 in which a next crossing is extracted.

On the other hand, in such a case that a crossing is not present between the present position and the forward position defined by the designated distance in the judgement of the step S205, the specific crossing is not located between the present position and the forward position defined by the designated distance (S240).

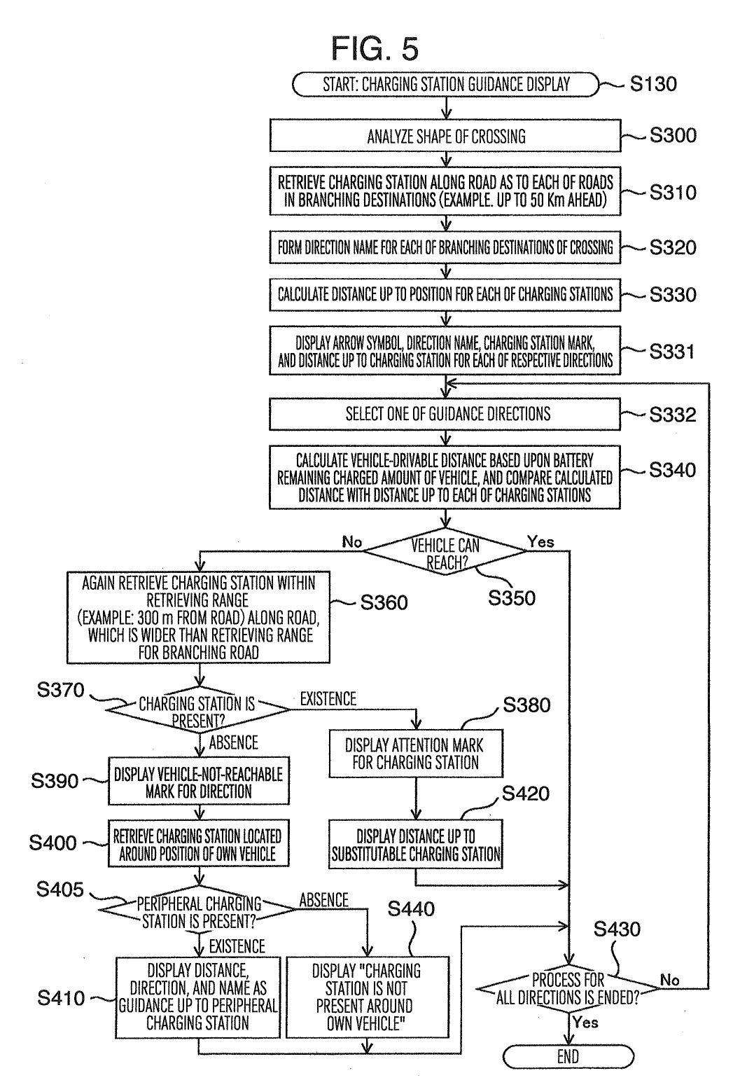

FIG. 5 is a process flow for describing the process (S130) for displaying the charging station guidance in FIG. 3. A description is made of the above-described process flow by employing as an example the display when the vehicle approaches the specific crossing shown in FIG. 2(b). Firstly, as to a crossing which is to be guided, the charging station guiding means 13 extracts a road connected to the node thereof so as to analyze a shape of this crossing, and when a link extended from a road where the vehicle is presently being driven is assumed as an enter link, the charging station guiding means 13 judges driving directions of respective roads with respect to the roads (roads where vehicle is not presently being driven) which escape from the crossing (S300). This driving direction can be calculated based upon positional coordinates of a starting point and an end point of each of the road links.

Next, the charging station guiding means 13 retrieves a charging station located along a road for each of branched destinations (S310). Such a charging station that a number of a road link connected to a crossing which is to be guided is made coincident with a number recorded in the column of the road link recorded in the charging station DB 22, which is one of the information about the respective charging stations, corresponds to a charging station located along the road connected to the crossing. It should be noted that when there is no charging station, since there are some possibilities that a process may become very long, as a range to be retrieved, this range must be defined up to a predetermined distance along the road, for example, defined from this crossing up to 50 Km ahead. Since a distance of a road approximated by polygonal lines can be calculated based upon coordinate data of a road shape corresponding to one of the attribute information of the road link, the road distance in the case that the road link is traced can be calculated.

When the charging station can be retrieved, an address corresponding to the attribute information of this charging station is read and is defined as a name of a direction. As to a direction along which a charging station is not present, shape data of cities, towns, and villages recorded in the map DB 23 are read, and a city, town and village name of a place located ahead of the above-described crossing by 50 Km, which constitutes an edge of a retrieving range is acquired and is defined as a name of a direction (S320). After charging stations have been retrieved as to the respective branched destinations, distances from the present position up to the respective charging stations are calculated (S330).

Based upon the above-described processed results, the charging station guiding means 13 displays the arrow marks 34 and the direction names in accordance with the branching directions for the respective branching directions of the specific crossing which is to be guided, and when the charging stations are present in the branching destinations, displays the charging station marks 37 and distances up to the relevant charging stations (S331). In order that the charging station guiding means 13 performs the displays, the charging station guiding means 13 transmits contents to be displayed via the system control 10 to the HMI means 12, and the HMI means 12 displays the processed results on the display means 11 in accordance with the contents.

Next, the charging station guiding means 13 selects one branching destination as a guidance direction (S332); a power consumption amount per unit distance is acquired by the battery remaining charged amount monitoring means 25; the charging station guiding means 13 calculates a remaining vehicle-drivable distance by dividing the remaining charged amount of the battery by this numeral value; and if a charging station is present along the road of the selected branching destination, compares the calculated vehicle-drivable distance with a distance up to the above-described charging station (S340). Then, the charging station guiding means 13 judges whether or not the distance up to the charging station located in the selected guidance direction is longer than the vehicle-drivable distance (S350). If the vehicle can reach the charging station located in the selected guidance direction, then the charging station guiding means 13 checks whether or not the process has been accomplished with respect to all the guidance directions (S430). When the process has been completed for all the guidance directions, the process flow is accomplished. When unprocessed guidance directions are left, the process flow is returned to the step S332 in which the charging station guiding means 13 selects one of the unprocessed guidance directions and continues the process.

When it is judged in the judgement of the step 350 that the vehicle cannot reach the charging station located along the road of the selected guidance direction, the charging station guiding means 13 again retrieves a charging station as to the branching road of this guidance direction within a range which is wider than the range along the road of this direction. For example, the charging station guiding means 13 retrieves the charging station up to a place separated from the road by 300 m along the road width direction (S360). A road link has a positional coordinate as to a vertex of a polygonal line indicative of a road shape. The charging station guiding means 13 retrieves the positional information of the charging station DB 22 so as to check whether or not a charging station is located within a range separated from respective line segments of the above-described polygonal line by 300 m. The charging station guiding means 13 judges whether or not the charging station is present by retrieving the above-explained positional information (S370), and if the charging station is present, then the attention mark 35 is plotted beside the charging station mark 37 of the relevant guidance direction. If the charging station is not present, then the vehicle cannot reach the charging station in this guidance direction, so that the warning mark 36 is plotted (S390).

In this case, since charging operation must be quickly performed before the vehicle is branched to this guidance direction, the charging station guiding means 13 retrieves charging stations which also cover a charging station not located along the road and are located around, for example, a circle having a radius of 5 Km while a position of the own vehicle is set to a center (S400). Then, the charging station guiding means 13 judges whether or not a charging station is found out around the position of the own vehicle (S405); when the charging station is found out, the charging station guiding means 13 plots the mark 38 of this charging station on the map, and furthermore, displays as an indication 39 for guiding the nearest charging station on the lower right portion of the screen, a distance up to the nearest charging station, a branching direction of a road at a crossing for guiding this charging station, and a name of the charging station (S410). If the charging station cannot be found out around the position of the own vehicle, then such a message of “a charging station is not present near the own vehicle” is displayed on the lower right portion of the screen (S440). In accordance with the present guidance, even under the condition that the route has not been set, the guidance is automatically displayed by performing the guidance display in front of the specific crossing corresponding to such a crossing where there are large possibilities that the vehicle is branched, so that the vehicle driver is not bothered. Moreover, since the guidance is displayed at a limited place called as a specific crossing, it is possible to avoid an excessive amount, or a shortage of guidance displays, which can prevent overlooking of the vehicle driver. Also, at this time, if the vehicle can reach the charging stations of all the directions, then the guide display may be alternatively deleted so as not to perform the guidance display. In this alternative case, while a frame buffer into which the contents to be displayed have been drawn by the process of the step S331 is duplicated (is made of double buffers), the guidance may be actually displayed after the process flow is branched to “No” in the branching process of the step S350.

Furthermore, in the case that the charging station is present around the branching road in the judging step S370, the charging station guiding means 13 displays the attention mark 35 as to the charging station mark 37 of the relevant guidance direction (S380), calculates a distance up to a substitute charging station which is found out instead of the charging station located along the branching road.

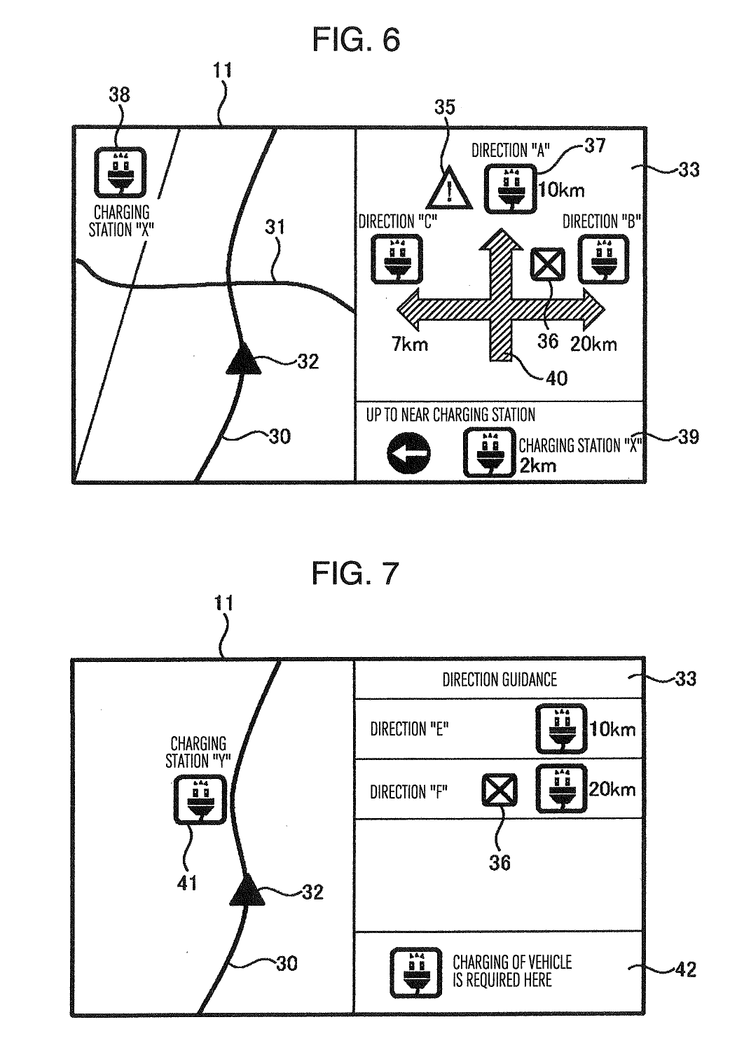

FIG. 6 shows a guidance display made by changing the format of the guidance display of FIGS. 2A and 2B. A changed point of the display format is given as follows: That is, while the respective branching directions at the specific crossing are not indicated by the arrow marks 34, the respective branching directions are indicated by displaying a shape FIG. 40 which represents the crossing shape of the specific crossing. The shape FIG. 40 of the crossing is drawn based upon the number of respective road links connected to the crossing and directions of the respective roads. Display information as to the respective branching directions is identical to the display information of FIG. 2(b).

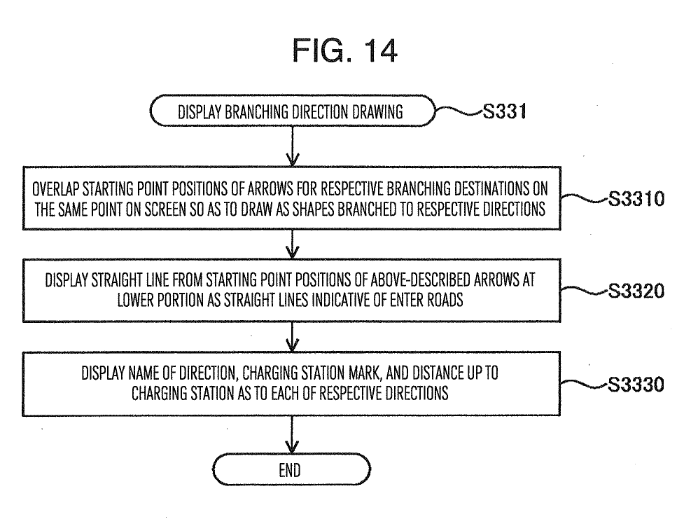

A drawing process for FIG. 6 is indicated in FIG. 14. The process of FIG. 14 is performed instead of the process of the step S331 in FIG. 5. Firstly, an arrow for each of the branching destinations is drawn as an arrow having a proper length and a proper width. At this time, starting positions of the respective arrows on the screen are matched with each other (S3310). Although the lengths of the arrows are set to ⅕ to 1/10 of the length of the screen along the longitudinal direction and the widths thereof are set to approximately 1/20 of the length of the screen along the longitudinal direction in FIG. 6, these lengths and widths of the arrows must be determined by considering a balance of the entire screen in embodiments. Next, as a line indicative of a road into which the own vehicle enters, a straight line is drawn from a starting position of the above-described arrow figure to a lower portion of the screen. A length of the straight line is made shorter than the length of the arrow and a width thereof is made equal to the width of the arrow. A deformed figure of the specific crossing is drawn in the above-described manner (S3320). Next, a direction name, a charging station mark, and a distance up to the charging station are drawn at a tip portion of each of the arrows (S3330). Since the shape of the specific crossing is deformed and the deformed shape is displayed, the vehicle driver can intuitively grasp the information of the charging stations for the respective branching destinations, as compared with that of FIG. 2(b).

Next, as timing at which guidance of charging stations is displayed, a description is made of an example of a guidance display at such a timing (2) when the charging station is detected instead of the specific crossing in front of the present position of the vehicle and located along the road where the vehicle is presently being driven. FIG. 7 is an example in which when the vehicle approaches a charging station located along the road where the vehicle is presently being driven, such a guidance is made which guides whether or not the battery of the vehicle should be charged at this charging station. While the vehicle is driven on a road 30, when the vehicle approaches a charging station 41 located along the road 30, guidance 33 is displayed on a right half portion of a screen. On an upper right portion of the screen, branching destinations at a specific crossing located further ahead of the charging station 41 to which the vehicle approaches on this road 30 are displayed as directions; situations for indicating whether or not charging stations are present in the respective branching directions are displayed; distances measured up to these charging stations are displayed; and the warning mark 36 for indicating whether or not the vehicle can reach thereto based upon the presently remaining charged amount of the battery is displayed. If the warning mark 36 is displayed, such a guidance 42 that charging of the battery is required at this place is displayed on a lower right portion of the screen.

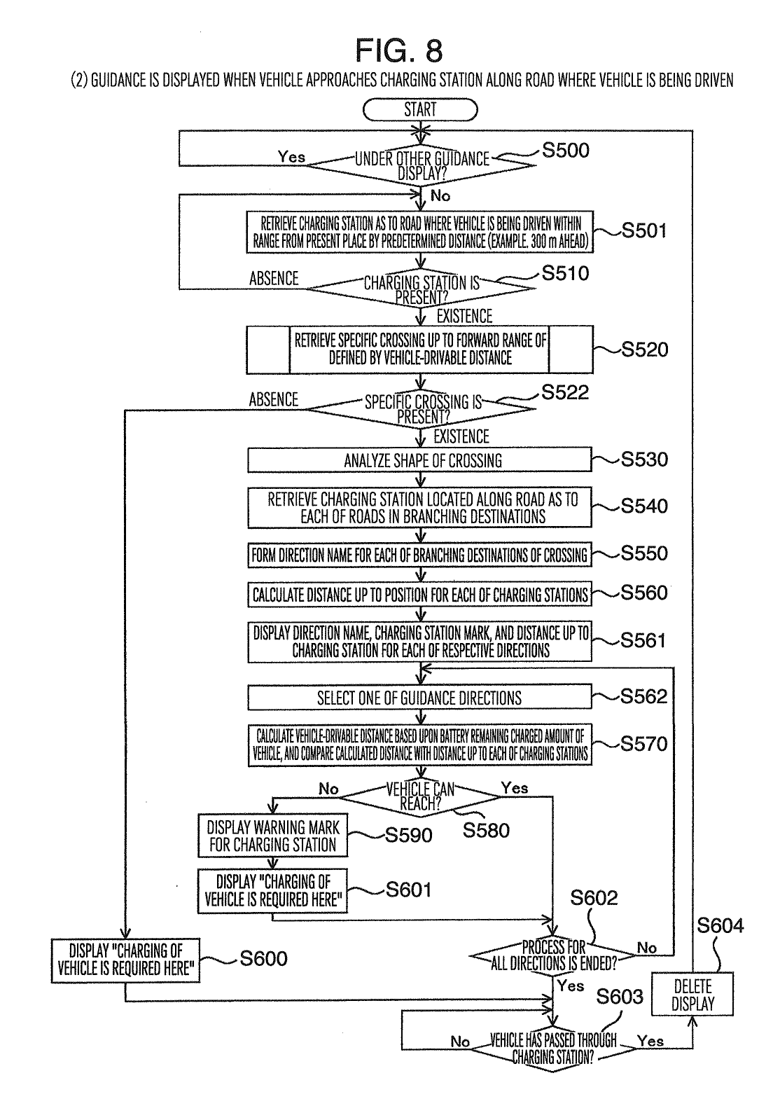

FIG. 8 is a process flow in the charging station guiding means 13 for performing the guidance display of FIG. 7. In order to prevent multiple guiding operations, the charging station guiding means 13 judges whether or not another guidance display is carried out (S500). When another guidance display is not carried out, the charging station guiding means 13 retrieves a charging station along a road where the vehicle is presently being driven within a range designated from the present position up to a forward position defined by a predetermined distance (for example, 300 m) (S501). Then, a process (S510) for judging whether or not the charging station is present within this designated range is periodically repeated so as to detect that the vehicle approaches the charging station. In such a case that it is judged that the charging station is present in the judgement of the step S510, the charging station guiding means 13 subsequently retrieves a specific crossing in front of the road where the vehicle is being driven up to a range of a distance over which the vehicle can be driven by the presently remaining charged amount of the battery (S520). Although this retrieving process of the specific crossing is executed in the same process flow shown in FIG. 4, the below-mentioned different point is present: That is, at this time, the presently drivable distance is designated as the distance designated as the range for retrieving the specific crossing, which is different from the process called from the step S110 of FIG. 3 in which the predetermined distance (for example, 300 m) is designated. The charging station guiding means 13 judges whether or not the specific crossing is detected in front of the charging station to which the vehicle approaches (S522); if the specific crossing is found out (S522: “Existence”), then the charging station guiding means 13 extracts roads connected to the node of this specific crossing so as to analyze a shape of a crossing; and when a link extended from the road where the vehicle is presently being driven is defined as an enter link, the charging station guiding means 13 judges driving directions of respective roads as to the roads escaped from the crossing (namely, roads where vehicle is not presently being driven) (S530).

Next, the charging station guiding means 13 retrieves a charging station located along a road for each of the branching destinations (S540). It should be understood that when there is no charging station, since there are some possibilities that a process is extremely prolonged, similar to the case of the step S310 of FIG. 5, a predetermined distance along a road is set as a range to be retrieved, for instance, a distance up to 50 Km from this specific crossing is set.

When the charging station can be retrieved, an address corresponding to the attribute information of this charging station is read and is defined as a name of a direction (S550). As to a direction along which a charging station is not present, shape data of cities, towns, and villages recorded in the map DB 23 are read, and a city, town and village name of a place located ahead of the above-described crossing which constitutes an edge of a retrieving range is acquired and is defined as a name of a direction. After charging stations can be retrieved along the roads as to the respective branching destinations, distances from the present position up to the respective charging stations are calculated (S560).

Based upon the above-described processed results, the charging station guiding means 13 displays as direction guidance 33 a direction name for each of the branching directions of the specific crossing, and displays the charging station marks 37 and distances up to the relevant charging stations when the charging stations are present in the branching destinations (S561).

Next, the charging station guiding means 13 selects one branching destination as a guidance direction (S562); a power consumption amount per unit distance is acquired by the battery remaining charged amount monitoring means 25; the charging station guiding means 13 calculates a remaining vehicle-drivable distance by dividing the remaining charged amount of the battery by this numeral value; and if a charging station is present along the road of the selected branching destination, then compares the calculated vehicle-drivable distance with a distance up to the above-described charging station (S570). Then, the charging station guiding means 13 judges whether or not the distance up to the charging station located in the selected guidance direction is longer than the vehicle-drivable distance (S580).

If the vehicle can reach the charging station located in the selected guidance direction (S580: Yes), then the charging station guiding means 13 checks whether or not the process has been accomplished with respect to all the guidance directions (S602). When the process has been completed for all the guidance directions, the charging station guiding means 13 continuously confirms whether or not the vehicle has passed through the charging station located along the road where the vehicle is being driven, which is found out in the step S500, based upon the information derived from the locator 17 (S603). When the charging station guiding means 13 judges that the vehicle has passed through this charging station, the guidance display is deleted (S604), and the process flow is returned to the first step from which a guiding process for a next charging station is continued. Also, if unprocessed guidance directions are left, then the process is returned to the step S562 in which one of the unprocessed guidance directions is selected and the process is continued. Also, at this time, if the vehicle can reach the charging stations of all the directions, then the guide display may be alternatively deleted so as not to perform the guidance display. In this alternative case, while a frame buffer into which the contents to be displayed have been drawn by the process of the step S561 is duplicated (is made of double buffers), the guidance may be actually displayed after the process flow is branched to “No” in the branching process of the step S580.

In such a case that the charging station guiding means 13 judges in the judging step S580 that the vehicle cannot reach the charging station located along the road of the selected guidance direction (S580: No), as to the branching road of the selected guidance direction, the vehicle cannot reach another charging station located ahead of the charging station to which the vehicle is approaching in this guidance direction, so that the warning mark 36 is drawn (S590), such a guidance 42 that “charging is required here” is displayed in the lower right potion of the screen (S601), and then, the process is advanced to the step S602. Also, in the case that the specific crossing is not detected in the step S522, the process is advanced to the step S600, and after such a guidance 42 that “charging is required here” is displayed in the lower right portion of the screen, the process is advanced to the step S603 in which the charging station guiding means 13 confirms that the vehicle passes through the charging station located along the road. In addition, when charging stations are present in high density, there is a risk that a large number of guidance is excessively displayed. As a consequence, when this guidance is made, the charging station guiding means 13 may alternatively judge whether or not a next charging station appears within a predetermined distance (for example, 5 Km) in addition to the judging process of the step S500; if “No” is judged, then the process may be advanced to the process of the step S501. Thus, after the guidance display has been once made, even when another charging station appears before the vehicle has passed a predetermined distance, the guidance display may not be alternatively performed.

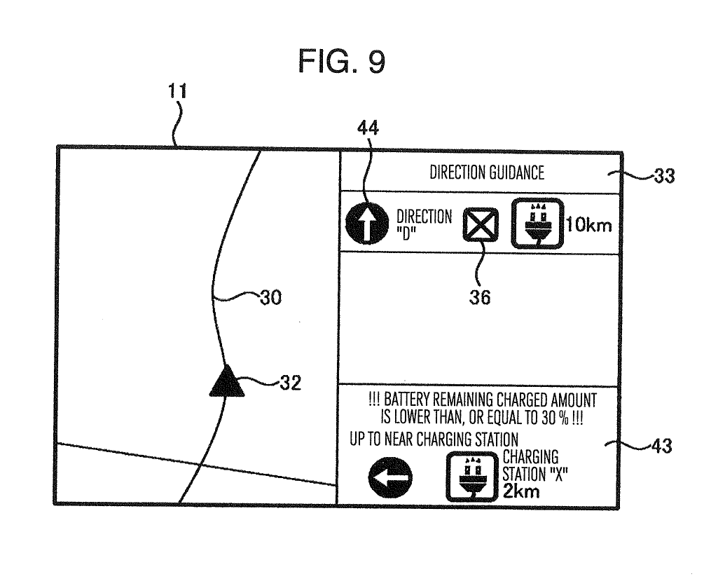

Next, as timing when a guidance display of a charging station is performed, a description is made of such an example for displaying guidance at timing (3) when a battery remaining charged amount of the own vehicle becomes lower than, or equal to a predetermined value. FIG. 9 shows an example of the guidance display when the remaining charged amount of the battery becomes lower than, or equal to the predetermined value. When the remaining charged amount of the battery becomes lower than, or equal to the predetermined value (for instance, lower than, or equal to 30%), in the direction guide 33, such an indication for indicating whether or not a charging station is present along the road 30 where the vehicle is presently being driven is made by an upper-directed arrow 44 functioning as the same direction as the driving direction, and moreover, another guidance 43 of a charging station is also made which is not located along the road 30, but is located around the present place.

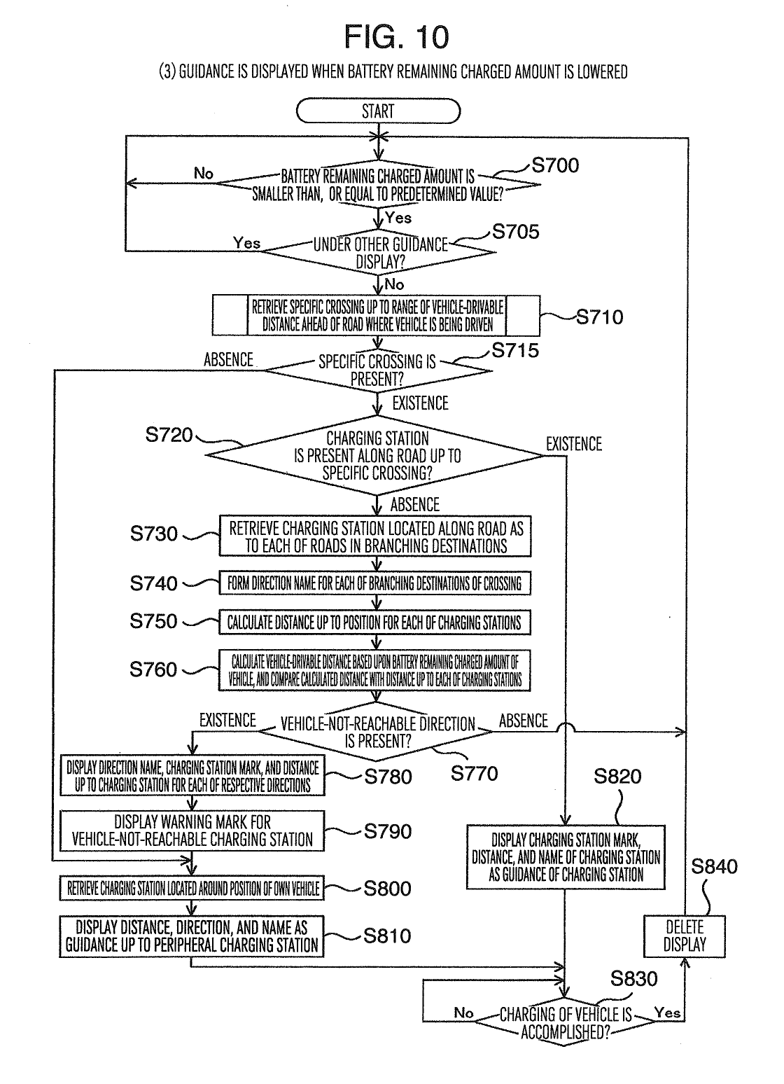

FIG. 10 is a process flow for performing a guidance display when a remaining charged amount of a battery is lowered as represented in the example of FIG. 9. The charging station guiding means 13 receives remaining charged amount information of the battery from the battery remaining charged amount monitoring means 25 and periodically judges whether or not the value of this remaining charged amount becomes smaller than, or equal to a predetermined value (for example, 30%) (S700). In the case that this value becomes smaller than, or equal to the predetermined value, if another process of guiding a direction has been carried out (S705: Yes), then guiding of the charging stations present within the vehicle-reachable range has already been carried out, so that the process is returned to the top step of this process flow. On the other hand, when displaying of the direction guidance is not carried out (S705: No), the specific crossing detecting means 18 detects a specific crossing from the present position up to the drivable distance ahead of the road where the vehicle is presently being driven (S710). This reason is given as follows: That is, if a charging station is located in front of the specific crossing, then guidance of this charging station is displayed, whereas if the charging station is not located in front of the specific crossing, then guidance of a charging station of a branching destination from the specific crossing is displayed. When the specific crossing is detected (S715: Existence), the charging station judging means 13 retrieves a charging station located along the road where the vehicle is being driven within the range from the present place up to the detected specific crossing so as to judge whether or not this charging station is present (S720).

If the charging station is present (S720: Existence), then a charging station mark, a name of this charging station, and a distance up to this charging station are displayed in order to display guidance for the charging station (S820). If the charging station is not present (S720: Absence), then, the charging station guiding means 13 retrieves charging stations present along the roads of the respective directions, which are branched from the specific crossing, in a similar manner to the steps S310 and S540 (S730), and forms names of the respective directions in a similar manner to the steps S320 and S550 (S740). Thereafter, the charging station guiding means 13 calculates distances up to the respective charging stations (S750), and compares the calculated distances with the drivable distance calculated based upon the remaining charged amount of the battery (S760). Then, if there is such a direction that the vehicle cannot reach the next charging station while there is no charging station between the present position and the reachable distance within the respective branching destinations (S770), then names, charging station marks, and distances up to the charging stations as to the respective directions are displayed (S780), and additionally, the warning mark 36 is displayed with respect to such a charging station to which the vehicle cannot reach (S790). Also, the warning mark 36 is displayed as to a direction where there is no charging station.

Then, the charging station guiding means 13 retrieves charging stations located around the position of the own vehicle (S800), and displays on the lower right portion of the screen, distances up to the retrieved charging stations, directions thereof, and names thereof as guidance up to the retrieved charging stations (S810). Also, in such a case that the charging station guiding names 13 judges that the specific crossing is not located between the present position and the drivable distance in the judging step S715 (S715: Absence), the process is advanced to the step S800 in which charging stations located around the present position are searched to be guided.

When the guidance displays of the charging stations are performed, charging of the battery is subsequently carried out based upon the remaining charged amount information of the battery derived from the battery remaining charged amount monitoring means 25; the charging station guiding means 13 continuously confirms whether or not a remaining charged amount becomes larger than, or equal to a predetermined value (S830); and if the remaining charged amount becomes the predetermined value, the charging station guiding means 13 deletes the guidance display (S840); and the process is returned to the top step of the process flow. In such a case that the charging stations are present along the roads of all the directions branched from the specific crossing and any of these charging stations are present within the vehicle-reachable distances (S770: No), since the needs can be satisfied by the charging station guidance of the direction guidance in the specific crossing, the process is returned to the top step of the process flow without making the guidance display in this case. In a place such as a big city that a large number of charging stations are present, it is conceivable that a frequency is high at which a vehicle encounters charging stations even if guidance of the charging stations is not intentionally made. Then, in a place such as a big city that large numbers of specific crossings as well as charging stations are present, direction guidance at these specific crossings is frequently displayed, and thus, it is conceivable such a possibility that an actually necessary display may be overlooked. However, in a mountain village place, it is conceivable that a total number of charging stations is small, and proper guidance of charging stations is required.

As a consequence, as a modification about the above-explained direction guidance at the specific crossing, the below-mentioned idea may be conceived: That is, while a detection is made of a total number of charging stations per unit area and located around a position of the own vehicle, when the total number of charging stations is smaller than, or equal to a predetermined numeral value, the direction guidance at the specific crossing described in the above-described embodiment is performed, so that the direction guidance is suppressed under such a condition that a total number of charging stations per unit area is larger than the predetermined numeral value and the charging stations may be easily found out.

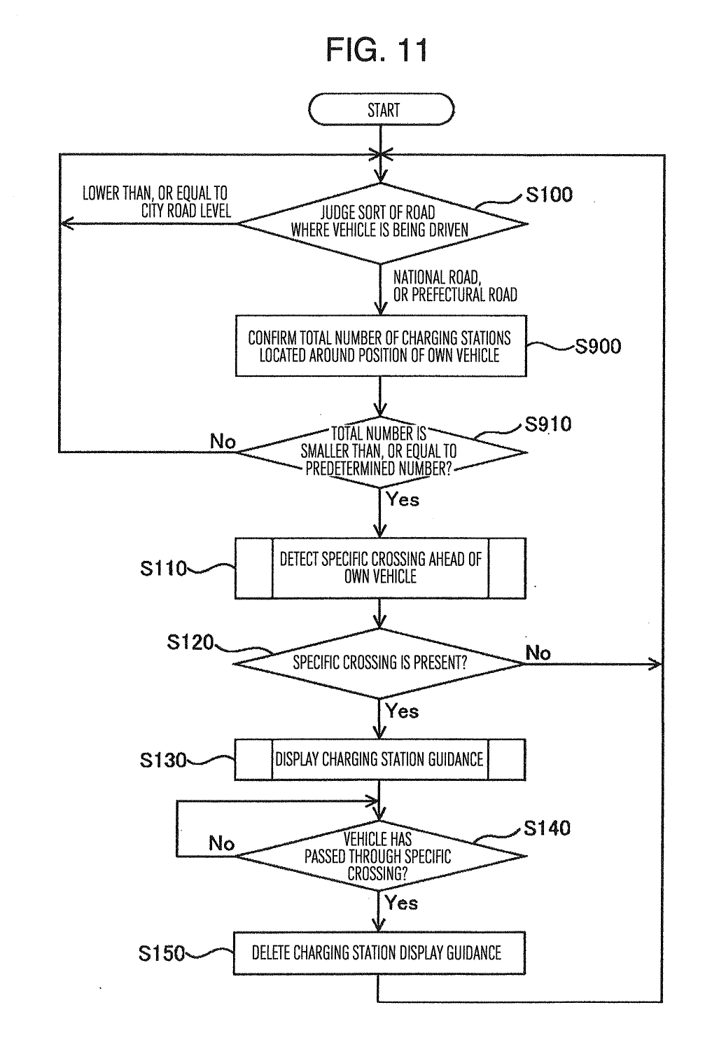

FIG. 11 is a process flow for performing a guidance display of a charging station in response to density of charging stations located around such a position of the own vehicle. After the charging station guiding means 13 judges that the vehicle is driven on either a national road or a prefectural road in a similar manner to the process shown in FIG. 3, the charging station guiding means 13 continuously retrieves charging stations having coordinates around the position of the own vehicle (for example, within square zone by 5 Km) and calculates a total number of the charging stations (S900). The charging station guiding means 13 judges whether or not the total number of charging stations is smaller than, or equal to a predetermined number (for instance, 3 stations/25 Km²) (S910), and when the total number is smaller than, or equal to the predetermined value, the process is advanced to the step S110 in which guidance at a specific crossing is performed. The succeeding processes are identical to those of FIG. 3. When a total number of charging stations is larger than the predetermined value, the process is not advanced to the guidance process, but is returned to the top step of the process flow.

As a result, when a total number of charging stations per unit area is smaller than, or equal to the predetermined numeral value, the guidance of the charging stations is performed, so that there is no guidance under such a condition that the charging stations can be easily found out, which can reduce the cumbersome feelings of the vehicle driver.

As previously described, since guidance of a charging station is properly performed at a specific crossing whose branching possibility is high under such a condition that setting of a route has not been performed, the charging station can be automatically guided even when a vehicle driver does not perform complex operation. The specific crossing defined in the present embodiment covers such a crossing which has been so far branched by the vehicle driver in addition to a major crossing where roads are crossed with each other whose levels are higher than, or equal to a level of a prefectural road. As a consequence, as to a road through which the vehicle driver has once passed, namely, a road which is covered in a living zone of the vehicle driver, the guidance thereof can be made even if a major crossing is not present. In such a case that the vehicle driver drives the own vehicle over a long distance while departing from her living zone, since the vehicle basically passes through the major crossings, it is advantage that the charging stations are guided based upon the guidance display at the specific crossings. Also, even in such an unusual case that the vehicle is driven on a road having a small number of branches, for example, a bypass road, when a charging station is present along the above-described road, since a guidance display is performed after a judgement is made whether or not a battery of this vehicle should be charged at this charging station, there is a small possibility that the vehicle driver is required to pay her attention to a remaining changed amount of the battery. Moreover, in the case that the remaining charged amount of the battery is lowered, since a guidance display is performed by guiding not only a charging station located along a road where the vehicle is being driven, but also a peripheral charging station when a necessity of the guidance display is high. As a result, since an excessive guidance display and a shortage of guidance display can be avoided, there is such an advantage that the vehicle driver can grasp the existence of the charging stations at proper timing.

1. A car navigation apparatus adaptable to an electric vehicle, comprising:
positioning means for positioning a present position of an electric vehicle to specify a road where the vehicle is being driven;
a map database for storing thereinto road information which includes a sort of roads;
a charging station database for storing thereinto a position of a charging station for the electric vehicle;
a drive history database for accumulating a drive history;
a battery remaining charged amount monitoring means for calculating a vehicle-drivable distance based upon a remaining charged amount of a battery mounted on the vehicle;
display means for displaying information;
specific crossing detecting means for judging whether or not a crossing located ahead of the road specified by said positioning means along a driving direction is a specific crossing for which a charging station should be guided; and
charging station guiding means for guiding the charging station; wherein:
in the case that said specific crossing detecting means judges that a forward crossing is the specific crossing,
said charging station guiding means reads a road which is connected to said forward crossing from said map database;
retrieves a charging station located along each of the read roads from said charging station database to calculate a distance up to each of said charging stations;
compares the distance up to each of said charging stations with the vehicle-drivable distance calculated by said battery remaining charged amount monitoring means to judge whether or not the vehicle can reach the charging station; and
displays a symbol for indicating whether or not the vehicle can reach the charging station on said display means based upon said judgement result in correspondence with a direction along which said charging station is present.

2. The car navigation apparatus adaptable to the electric vehicle as claimed in claim 1 wherein:
said specific crossing is a crossing where a specific sort of roads cross with each other, which is located ahead of a road where the vehicle is being driven by a predetermined distance, or a crossing where the vehicle turned its driving direction, which has been recorded in said drive history database.

3. The car navigation apparatus adaptable to the electric vehicle as claimed in claim 1 wherein:
in the case that said charging station guiding means judges that the vehicle cannot reach any one of the charging stations, said charging station guiding means retrieves another charging station located within a predetermined range from said present position from said charging station database, and displays guidance of said retrieved charging station on the display means.

4. The car navigation apparatus adaptable to the electric vehicle as claimed in claim 1 wherein:
only in such a case that a total number of the charging stations present in an area around the present position within a predetermined range is smaller than, or equal to a predetermined value, said charging station guiding means displays guidance of the charging stations on said display means.

5. The car navigation apparatus adaptable to the electric vehicle as claimed in claim 1 wherein:
when the vehicle approaches a charging station located along the road where the vehicle is being driven, which is specified by said positioning means,
said charging station guiding means furthermore retrieves whether or not a charging station is located ahead of the first-mentioned charging station; and
when said charging station guiding means judges that the vehicle cannot be driven up to said forward charging station by comparing the vehicle-drivable distance calculated by said battery remaining charged amount monitoring means with a distance up to said forward charging station, said charging station guiding means displays guidance which prompts charging of the battery at said charging station to which said vehicle approaches on said display means.
